(19) United States
(12) Patent Application Publication
(10) Pub. No.: US 2024/0202846 A1
(43) Pub. Date: Jun. 20, 2024

(54) REAL ESTATE LISTING, MATCHING, AND TRANSACTIONS WITH MULTI-LEVEL VERIFICATION USING BLOCKCHAIN

(71) Applicant: REai, Inc., Atlanta, GA (US)

(72) Inventor: James Wang, Duluth, GA (US)

(21) Appl. No.: 18/543,505

(22) Filed: Dec. 18, 2023

Related U.S. Application Data
(60) Provisional application No. 63/387,821, filed on Dec. 16, 2022.

(51) Int. Cl. G06Q 50/16

(52) U.S. Cl. CPC G06Q 50/16

(57) ABSTRACT

Embodiments include systems and methods for listing, matching, and transacting properties on a blockchain network with different levels of verification. Embodiments are configured to obtain, by a smart contract operating on a blockchain-based distributed computer network, public information for a real estate property and private information for the real estate property. In response to a public request for information, embodiments then provide, by the smart contract, the public information via a public access layer of the blockchain-based distributed computer network. In response to a private request for information, embodiments provide, by the smart contract, the private information via a privileged access layer of the blockchain-based distributed computer network.

### CROSS-REFERENCE TO RELATED APPLICATION

This U.S. non-provisional application claims priority under 35 U.S.C. § 119 to U.S. Provisional Patent Application No. 63/387,821, filed on Dec. 16, 2022, in the United States Patent and Trademark Office, the disclosure of which is incorporated by reference herein in its entirety.

### BACKGROUND

The following relates generally to automated listing generation and user matching, and more specifically to automated real estate listing, matching, and transactions on a blockchain-based network.

Blockchain technology is a decentralized, distributed ledger that records the transactions and ownership of a digital asset. A blockchain is essentially a chain of blocks, each containing data, and that are linked together using cryptography. Blockchains enable a secure record of data, and are designed to generate trust in transactions without the need for a trusted third party. This technology underpins various cryptocurrencies, and can be used for a wide range of applications beyond currencies including supply chain management, digital identity verification, voting systems, and transferring ownership rights of other assets.

Some available blockchain technologies extend their functionality with the use of smart contracts. Smart contracts are self-executing contracts with the terms of the agreement between buyer and seller being directly written into lines of code. Some smart contracts operate without a buyer or seller, e.g., in response to an information from an oracle or in response to a query. They operate on blockchain technology and are automatically executed, controlled, and documented by the blockchain when pre-defined conditions are met. Smart contracts eliminate the need for intermediaries, thus reducing transaction costs and increasing transaction speed and transparency.

### SUMMARY

The present disclosure describes methods for generating listings and responding to queries of those listings according to a privilege hierarchy. Embodiments are further configured to automatically update existing listings, to execute transactions between users, and to match users to other users or to properties. Embodiments include a smart contract component configured to deploy various smart contracts into a blockchain-based distributed computer network, where the smart contracts include code from or otherwise incorporate one or more machine learning (ML) models. The smart contracts are further able to add blocks to the blockchain with varying levels of access, effectively creating a privileged access layer of the blockchain.

A method, apparatus, non-transitory computer readable medium, and system for automated real estate listing, matching, and transactions on a blockchain-based network are described. One or more aspects of the method, apparatus, non-transitory computer readable medium, and system include obtaining, by a smart contract operating on a blockchain-based distributed computer network, public information for a real estate property and private information for the real estate property; providing, by the smart contract, the public information via a public access layer of the blockchain-based distributed computer network in response to a public request for information about the real estate property; and providing, by the smart contract, the private information via a privileged access layer of the blockchain-based distributed computer network in response to a verified request for information about the real estate property.

An apparatus, system, and method for automated real estate listing, matching, and transactions on a blockchain-based network are described. One or more aspects of the apparatus, system, and method include at least one processor; at least one memory storing instructions executable by the at least one processor; a public blockchain component configured to provide public information via a public access layer of a blockchain-based distributed computer network in response to a public request for information about a real estate property; and a privileged blockchain component configured to provide private information via a privileged access layer of the blockchain-based distributed computer network in response to a verified request for information about the real estate property.

### BRIEF DESCRIPTION OF THE DRAWINGS

FIG. 1 shows an example of a real estate matching system according to aspects of the present disclosure.

FIG. 2 shows an example of a real estate matching apparatus according to aspects of the present disclosure.

FIG. 3 shows an example of a pipeline for smart contract creation according to aspects of the present disclosure.

FIG. 4 shows an example of a pipeline for listing generation according to aspects of the present disclosure.

FIG. 5 shows an example of a pipeline for buyer to seller matching according to aspects of the present disclosure.

FIG. 6 shows an example of a pipeline for buyer or seller to agent matching according to aspects of the present disclosure.

FIG. 7 shows an example of a pipeline for vendor matching according to aspects of the present disclosure.

FIG. 8 shows an example of public and private layers according to aspects of the present disclosure.

FIG. 9 shows an example of listing generation models according to aspects of the present disclosure.

FIG. 10 shows an example of a property compliance pipeline according to aspects of the present disclosure.

FIG. 11 shows an example of a layout generation pipeline according to aspects of the present disclosure.

FIG. 12 shows an example of a method for retrieving privileged information according to aspects of the present disclosure.

FIG. 13 shows an example of a method for automated listing generation and user matching according to aspects of the present disclosure.

FIG. 14 shows an example of a computing device according to aspects of the present disclosure.

### DETAILED DESCRIPTION

Blockchain technology provides a secure, immutable ledger for recording transactions and ownership of digital assets. Some of the available blockchains further provide smart contract compatibility, enabling the automation of transactions and data generation. However, conventional blockchain systems do not differentiate users based on their access-level privilege. Accordingly, the conventional systems are not suited for transactions necessitating private or confidential data. For example, agents in the real estate may require sensitive information about buyers and sellers such as a social security number as a part of a vetting process.

The present disclosure includes methods for enabling multi-level verification on a blockchain-based distributed computer network. The methods provided herein may be applied to many domains. However, the present disclosure focuses on methods for automating and facilitating real estate processes, such as generating listings, providing the listings, and enabling various transactions.

A conventional process of transacting a property involves the seller first engaging with a seller agent. The seller agent typically comes to visit the property, take photos, and collect other information. The agent then manually prepares a listing and adds it to a centralized database such as the Multiple Listing Service (MLS). Then, a buyer agent representing a buyer searches the MLS to find a property suitable for their buyer. If the buyer agent happens to locate the listing described above, and if the buyer agent deems the listing as a fit, the buyer agent will then notify the buyer, at which point the buyer places an offer.

At this point, the transaction process proceeds manually, typically including multiple negotiations, concessions, drawing up legal documents, and even making adjustments to the property such as renovations. This process is time consuming, expensive, and may not result in the best fit for the buyer or seller in the case of oversights from the agents, or in the case of missing the property in the listings.

Blockchain-based distributed computer networks are an alternative to databases such as the MLS. Blockchain systems are more powerful than centralized database in many aspects. For example, blockchain systems can be scaled indefinitely, provide access to users all around the world, and existing entries (blocks) to the ledger cannot be modified by bad actors due to the cryptographic linkage between blocks-if a single block is changed, all subsequent blocks would need to change to be valid, which is practically impossible due to the proof-of-work and proof-of-stake validation systems. Blockchains that are extended with smart contracts can further automate transactions, by only enabling transactions that meet certain criteria laid out in the smart contract. However, existing systems do not include features for handling private or sensitive information.

Embodiments described herein include one or more privileged layers on the blockchain that allow for the secure processing of confidential data while maintaining the transparency and integrity of public data. The private layers are designed to handle sensitive information integral to real estate transactions, such as personal details of buyers and sellers, financial records, and proprietary property information. These private layers ensure that confidential data remains protected and accessible only to authorized parties. In some cases, the privileged layers may be used to store privileged data that is not necessarily sensitive, but that can be gated to other privileged users. As used herein, “private” is used interchangeably with “privileged.” In some examples, “private” refers to a type of layer that is a subset of a “privileged” type.

Embodiments improve on existing automated transaction systems by combining the authentication and verification features of blockchain systems with the privacy features of multi-tiered access layers. This allows automation to be performed by smart contracts with access to the privileged data, without exposing the privileged data to the public. Additionally, the integration of AI-driven algorithms within this system enhances decision-making and efficiency, tailoring transactions and interactions to the specific needs of participants. The smart contracts and the trained ML models they are powered by have access to the entirety of the blockchain.

This structure not only ensures the security and confidentiality of sensitive data but also maintains the transparency and trustworthiness inherent in public blockchain systems. The dual-layered approach of private and public layers in this blockchain architecture streamlines the handling of complex real estate transactions, which typically involve a mix of public and private information. By segregating this data appropriately, the system ensures that each transaction adheres to the necessary privacy standards while still benefiting from the immutable and decentralized nature of blockchain technology. This results in a more efficient, secure, and user-centric transaction process, addressing key limitations of current blockchain applications in sensitive domains such as real estate.

Embodiments include systems and methods for users to list a property with a process that is streamlined with AI-powered smart contracts. Embodiments implement a privileged layer onto a blockchain that enables the selective viewing and processing of the information. Some embodiments further ensure that the listings are compliant with all regulations by generating the content using trained AI models whose outputs are controlled to be compliant. Some embodiments match users to properties or to other users using trained AI models. Some embodiments further provide analysis, projections, and recommendations based on the new listing or the existing listings.

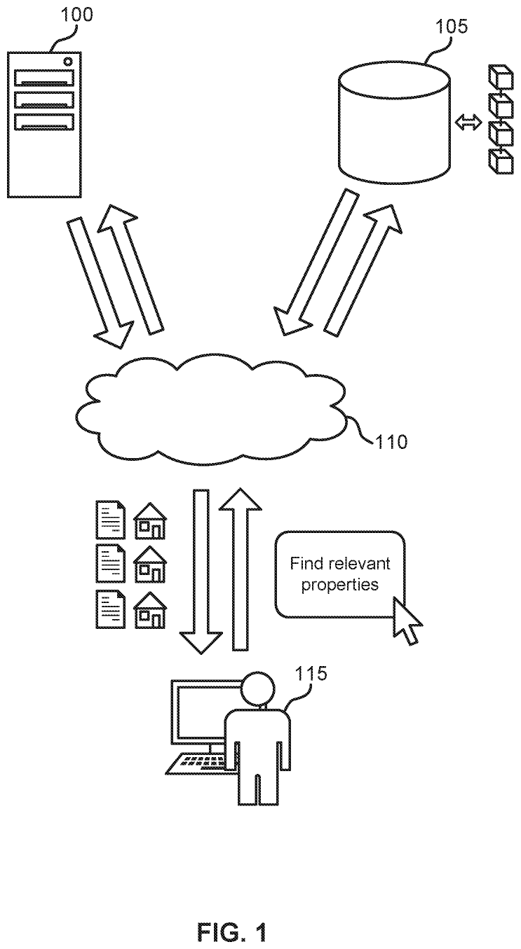

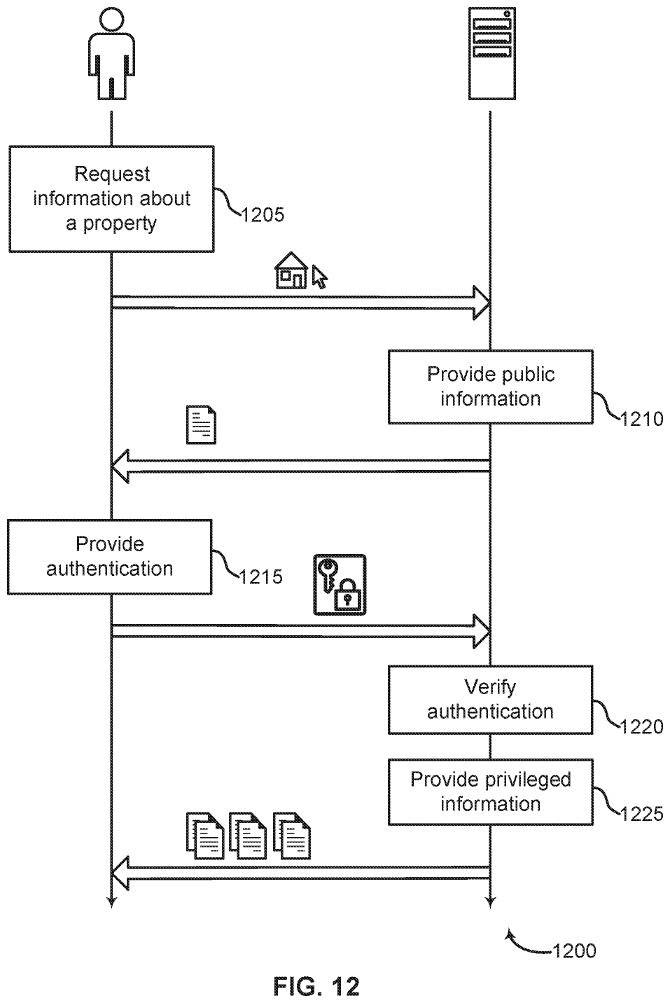

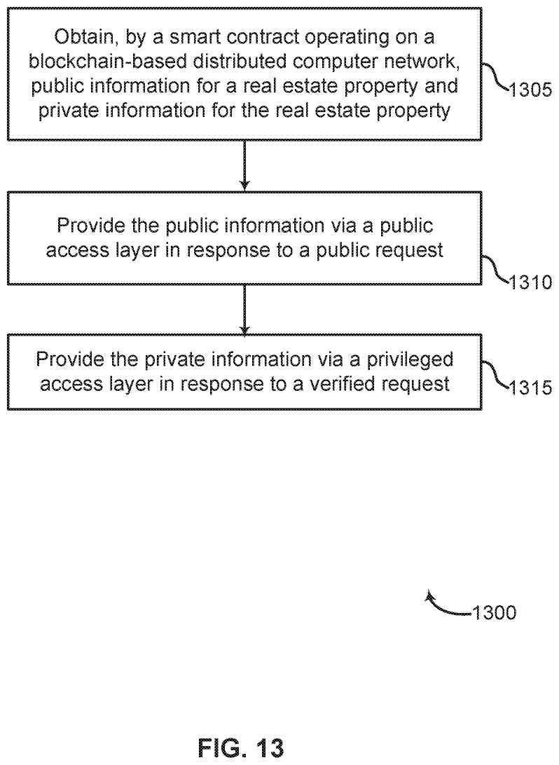

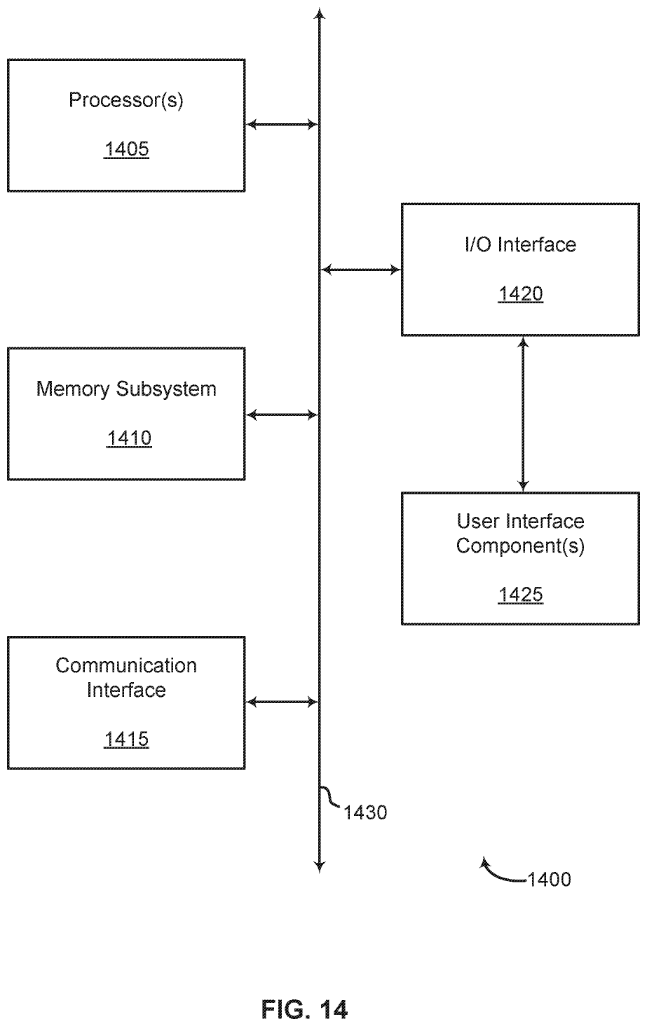

A real estate matching system is described with reference to FIGS. 1-11. Matching methods and information query methods are described with reference to FIGS. 12-13. A computing device configured to implement a real estate matching apparatus is described with reference to FIG. 14.

### Real Estate Matching System

An apparatus for automated real estate listing, matching, and transactions on a blockchain-based network is described. One or more aspects of the apparatus include at least one processor; at least one memory storing instructions executable by the at least one processor; a public blockchain component configured to provide public information via a public access layer of a blockchain-based distributed computer network in response to a public request for information about a real estate property; and a privileged blockchain component configured to provide private information via a privileged access layer of the blockchain-based distributed computer network in response to a verified request for information about the real estate property.

Some examples of the apparatus, system, and method further include a smart contract component configured to create and execute a smart contract, wherein the smart contract operates on the blockchain-based distributed computer network. In some aspects, the smart contract includes instructions configured to compute a plurality of component rating factors using a plurality of machine learning models; and compute the plurality of component rating factors using an ensemble algorithm to obtain a property matching prediction. In some aspects, the smart contract includes instructions configured to perform a private transaction via the privileged access layer of the blockchain-based distributed computer network, wherein the private transaction transfers a property right for the real estate property.

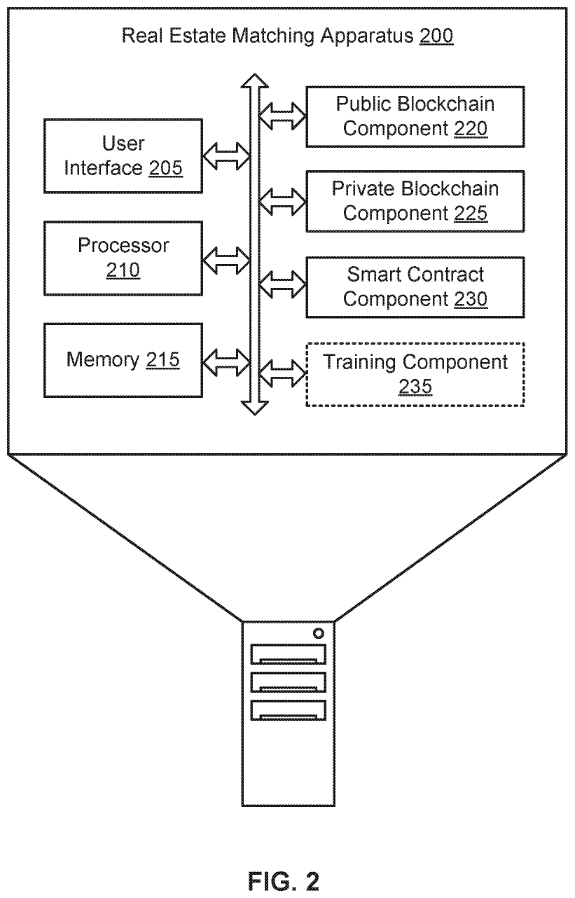

FIG. 1 shows an example of a real estate matching system according to aspects of the present disclosure. The example shown includes real estate matching apparatus 100, database 105, network 110, and user interface 115. Real estate matching apparatus 100 is an example of, or includes aspects of, the corresponding element described with reference to FIG. 2. User interface 115 is an example of, or includes aspects of, the corresponding element described with reference to FIG. 2. For example, user interface 115 may be implemented on an edge user device as shown in FIG. 1, or may be implemented directly on real estate matching apparatus 100 as shown in FIG. 1.

In an example, a user provides an information request via user interface 115. The information request might be a request for information about a specific property, or generally to find relevant properties or services. Then, real estate matching apparatus 100 processes the request. In some cases, the processing includes verifying a permissions level of the user. The processing may further include utilizing a smart contract to automatically perform sub-tasks related to the request. The sub-tasks may involve retrieving information from database 105. In some cases, database 105 is an index database of data from a blockchain. In some cases, operations with database 105 refers to operations with the blockchain directly. Real estate matching apparatus 100 then provides a result of the request for information to the user via user interface 115.

Embodiments of real estate matching apparatus 100 include hardware and software components that are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Database 105 is configured to store information used by real estate apparatus 100, including indexed data from a blockchain, machine learning model parameters, cached code or boilerplate used in smart contract generation, user parameters, etc. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with a database controller. In other cases, a database controller may operate automatically without user interaction. As used herein, database 105 may also directly refer to a distributed blockchain structure. According to some aspects, an offline database may interact with data that is stored “on chain.” For example, one or more identifiers may be stored on chain, and corresponded with an offline database to enable additional data storage. Database 105 may implement such a combined system.

Network 110 facilitates the transfer of information between real estate matching apparatus 100, database 105, and a user, e.g. through user interface 115. In some cases, network 110 is referred to as a “cloud”. A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location. A cloud may also refer to a distribution of nodes that store a blockchain and perform operations thereon.

User interface 115 enables a user to interact with a device. In some embodiments, the user interface 115 may include an audio device, such as an external speaker system, an external display device such as a display screen, or an input device (e.g., remote control device interfaced with the user interface 115 directly or through an IO controller module). In some cases, a user interface 115 may be a graphical user interface 115 (GUI).

FIG. 2 shows an example of a real estate matching apparatus 200 according to aspects of the present disclosure. The example shown includes real estate matching apparatus 200, user interface 205, processor 210, memory 215, public blockchain component 220, private blockchain component 225, smart contract component 230, and training component 235. Real estate matching apparatus 200 is an example of, or includes aspects of, the corresponding element described with reference to FIG. 1. User interface 205 is an example of, or includes aspects of, the corresponding element described with reference to FIG. 1.

Embodiments of real estate matching apparatus 200 include several components and sub-components. These components are variously named and are described so as to partition the functionality enabled by the processor(s) and the executable instructions included in the computing device used in real estate matching apparatus 200 (such as the computing device described with reference to FIG. 14). In some examples, the partitions are implemented physically, such as through the use of separate circuits or processors for each component. In some examples, the partitions are implemented logically via the architecture of the code executable by the processors.

Embodiments of real estate matching apparatus are configured to interface with and perform operations on a blockchain. A blockchain is a distributed ledger technology that is used to record transactions and data in a way that is secure, transparent, and verifiable. It consists of a decentralized network of computers, or nodes, that are connected over the internet and work together to validate and record transactions on a shared digital ledger. Each transaction that is recorded on the blockchain is added to a block, which is then cryptographically linked to the previous block in the chain. This creates a permanent and unchangeable record of all the transactions that have taken place on the blockchain.

One of the key features of some blockchains is that they are decentralized, meaning that they are not controlled by a single entity or organization. Instead, it is maintained by a network of participating nodes, which work together to validate and record transactions on the ledger. This makes it resistant to tampering and ensures that the information recorded on the blockchain is accurate and trustworthy. Blockchains are used in a variety of applications, including cryptocurrency, supply chain management, and voting systems. They are known for their security, transparency, and ability to create a permanent and verifiable record of transactions.

Public blockchain component 220 interfaces with a public layer of the blockchain. When a user makes a public request for information, public blockchain component 220 queries the public layer of the blockchain for the information and returns it. Public blockchain component 220 further prevents unauthorized users from accessing information from privileged layers of the blockchain. Private blockchain 225 interfaces with a private layer of the blockchain. When a user makes a verified request for information, public blockchain component 220 queries a corresponding privileged layer of the blockchain for the information and returns it.

Computing systems (e.g., networks) may implement security measures to prevent unauthorized users (e.g., devices) from accessing system resources such as system information, data, hardware, software, applications, etc. For instance, computing systems may employ authentication procedures to authenticate a user (e.g., confirm a user's claimed identity) prior to granting the user access to restricted system resources. In an authentication procedure, a user may provide one or more credentials that may be authenticated by the computing system for the user to gain access to system resources. For example, a user may provide credentials such as a username, a password, a gesture, a biometric signature (e.g., a fingerprint), a personal identification number (PIN), processing fees associated with privileged blockchain access, etc. The computing system may compare credentials provided by the user with previously established credentials associated with the user to determine whether to permit or deny access requested by the user (e.g., where the previously established credentials may be registered with the computing system prior to the authentication procedure).

According to some aspects, private blockchain component 225 provides, by the smart contract, the private information via a privileged access layer of the blockchain-based distributed computer network in response to a verified request for information about the real estate property. In some examples, private blockchain component 225 performs, by the smart contract, a private transaction via the privileged access layer of the blockchain-based distributed computer network, where the private transaction transfers a property right for the real estate property.

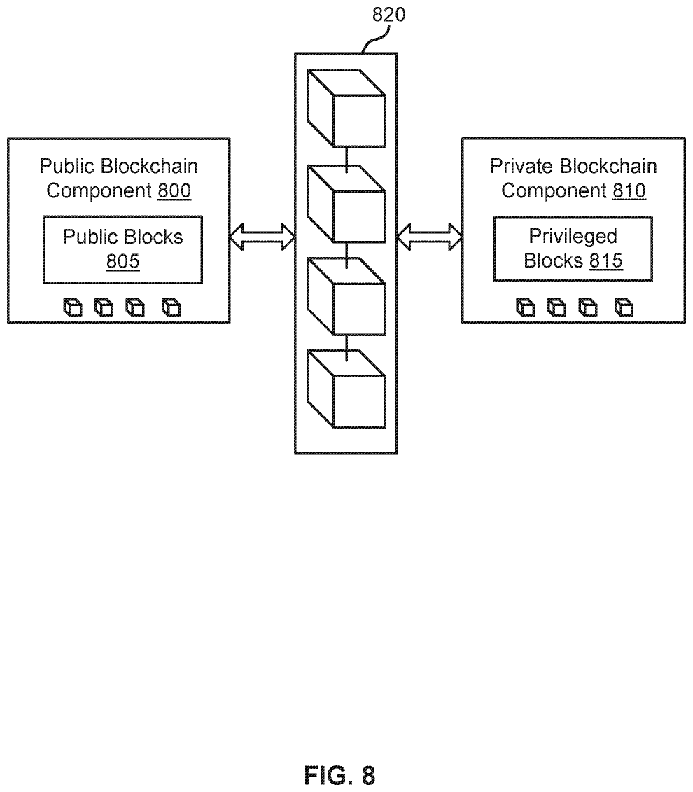

In some examples, private blockchain component 225 receives, by the smart contract, a first verification from a first user via the privileged access layer of the blockchain-based distributed computer network. In some examples, private blockchain component 225 receives, by the smart contract, a second verification from a second user via the privileged access layer of the blockchain-based distributed computer network, where the private transaction is performed based on the first verification and the second verification. In some examples, private blockchain component 225 transfers, by the smart contract, a monetary value via the privileged access layer of the blockchain-based distributed computer network in response to a verified transaction. In some examples, private blockchain component 225 identifies a sender of the verified request. In some examples, private blockchain component 225 verifies an authorization of the sender, where the private information is based on the authorization. Private blockchain component 225 is an example of, or includes aspects of, the corresponding element described with reference to FIG. 8. Public blockchain component 220 is an example of, or includes aspects of, the corresponding element described with reference to FIG. 8.

Smart contract component 230 is configured to generate smart contracts including code interpretable and executable by the blockchain. Embodiments of smart contract 230 include machine learning (ML) models to enable the “AI-powered” smart contracts referenced herein. Embodiments of smart contract component 230 include a listing generation model, an image information extraction model, a price prediction model, a description generation model, a room classification model, a compliance classification model, and object detection model, a video information extraction model, or a combination thereof.

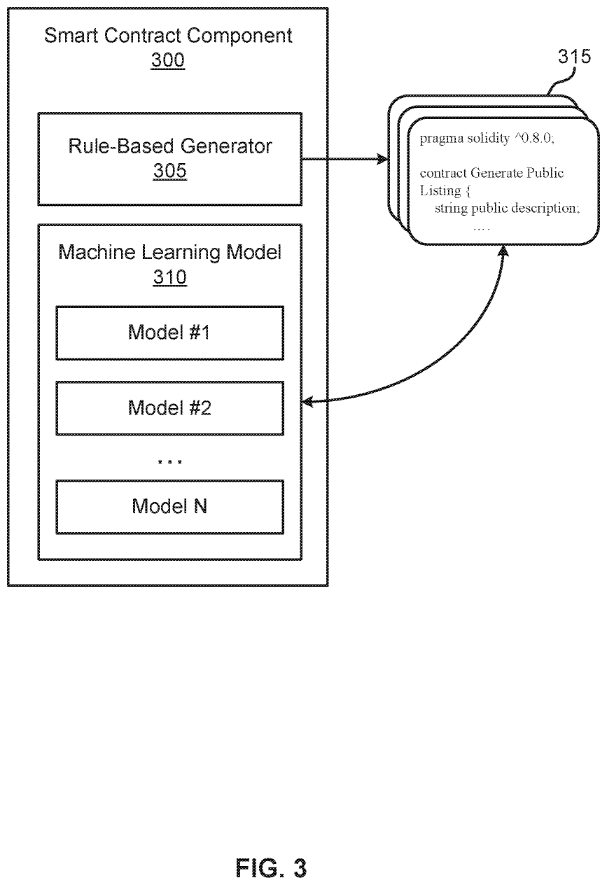

According to some aspects, smart contract component 230 is configured to create and execute a smart contract, wherein the smart contract operates on the blockchain-based distributed computer network. In some aspects, the smart contract includes instructions configured to: compute a set of component rating factors using a set of machine learning models; and compute the set of component rating factors using an ensemble algorithm to obtain a property matching prediction. In some aspects, the smart contract includes instructions configured to: perform a private transaction via the privileged access layer of the blockchain-based distributed computer network, where the private transaction transfers a property right for the real estate property. Smart contract component 230 is an example of, or includes aspects of, the corresponding element described with reference to FIG. 3.

Training component 235 is configured to update parameters of the AI/ML models of smart contract component 230. Training component 235 may train the models in a pre-training phase, and update the models in a fine-tuning phase. In some embodiments, training component 235 continually updates the models as the system is used. For example, according to some aspects, training component 235 identifies a transaction on the blockchain-based distributed computer network, and updates the machine learning model(s) based on the transaction.

FIG. 3 shows an example of a pipeline for smart contract 315 creation according to aspects of the present disclosure. The example shown includes smart contract component 300 and smart contract 315. In one aspect, smart contract component 300 includes rule-based generator 305 and machine learning model 310.

Smart contract component 300 may include a rule-based generator 305 used to generate smart contracts. For example, the rule-based generator 305 may include one or more template smart contract documents, and place the code of or the output generated by machine learning model 310 to generate the smart contract. In at least one embodiment, the a non-rule based model may be used to construct the smart contracts; for example, a trained ANN model may be used to generate a template, and then additions to the template may be made using meta-programming techniques.

Machine learning model 310 includes one or more trained models. Machine learning model 310 may be based on an artificial neural network (ANN). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

One or more of the AI/ML models included in machine learning model 310 may be a natural language generation (NLG) model. NLG models are configured to generate natural language or other parseable sequences, such as code, JSON data, etc. NLG models may include a transformer architecture configured to perform an attention operation.

A transformer or transformer network is a type of neural network models used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

Other models within machine learning model 310 may include a classification model. Classification models are trained on a set of training data and are configured to classify input data. For example, a classification model may process a listing and determine if it meets regulation standards learning during training. Specifically, the classification model may process an input vector representation of a listing, and then learned model such as an ANN may predict whether the listing adheres to regulations. If the listing does not adhere, it may be flagged for review by other models or by a subject matter expert.

Other models within machine learning model 310 may include image generative models configured to, for example, produce a schematic for a real estate property. The schematic may be generated by a generative architecture such as a diffusion model. In some embodiments, the schematic is generated into a vector representation that is interpretable by schematic rendering component downstream.

In some embodiments, machine learning model 310 predicts a match between a user and a user or a user and a property, given vector representations of the user(s) or properties as input. Some embodiments are configured to search an embedding space of user(s) and/or properties to make the match prediction.

According to some aspects, machine learning model 310 generates a property matching prediction in response to the verified request. In some aspects, the property matching prediction includes a ranking of a set of real estate properties. In some examples, machine learning model 310 computes a set of component rating factors using a set of machine learning models 310. In some examples, machine learning model 310 combines the set of component rating factors using an ensemble algorithm to obtain the property matching prediction. In some examples, machine learning model 310 identifies a user based on the property matching prediction, where the private information is provided to the user in response to the verified request.

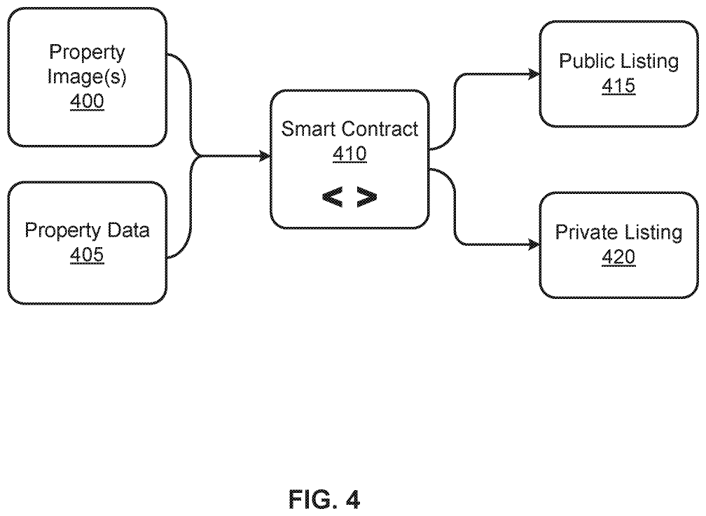

In some embodiments, smart contract component 300 generates a smart contract 315 including code executable by a blockchain to perform the functionality described above. Some embodiments of smart contract component 300 include one or more models configured to perform the methods described in U.S. Pat. No. 11,093,992, such as generating one or more rating factors for use in a smart matching process. Smart contract component 300 is an example of, or includes aspects of, the corresponding element described with reference to FIG. 2. Smart contract 315 is an example of, or includes aspects of, the corresponding element described with reference to FIGS. 4-7.

Some examples of smart contract 315 are configured to manage and enforce access rights and privileges for different levels of users. For example, some users are granted visibility to only the basic listings and information, whereas specific users may have access to more comprehensive information. Higher-level users can access premium information. For example, in some cases, property owners have the most extensive access, including private-only information. In some cases, transaction details are available exclusively to homeowners and buyers who make an offer.

Smart contracts such as smart contract 315 facilitate real estate transactions by processing private transaction data within secure private layers of the blockchain. This approach includes managing the flow of funds in various transaction scenarios, such as crowd-funding or joint ownership purchases, where the financial details are stored in the private layer and are accessible only to authorized users. Additionally, smart contracts connect users and properties through a matching algorithm. For instance, they link buyers to appropriate property listings based on the buyer's access rights and connect properties to listing agents for professional representation. These smart contracts can be generated from templates and incorporate functionality from AI/ML models, enhancing the process of listing, matching, and transacting properties on the blockchain.

In some cases, the generated smart contracts control the creation of different views of information, tailored to the access level of each user. For example, in a GUI such as a web-portal, a user may select different views of the listing according to their granted level of access. The views may display different sets of information, such as premium or privileged information about a property. Examples of premium information may include price projection, neighborhood trends, crime information, recent renovations made to the house, inspection results, warranty information, and the like. The smart contracts can assign and enforce access policies for private data, allowing for the distribution of information to different user groups with varying terminology and data requirements. The smart contracts are isolated from the data, permitting multiple policies per listing and enabling updates to policies without affecting other aspects of the system. In real estate sales transactions, such as offerings, mortgage processing, and insurance services, smart contracts operate within the private layers, ensuring that sensitive data is processed securely and remains inaccessible to general users.

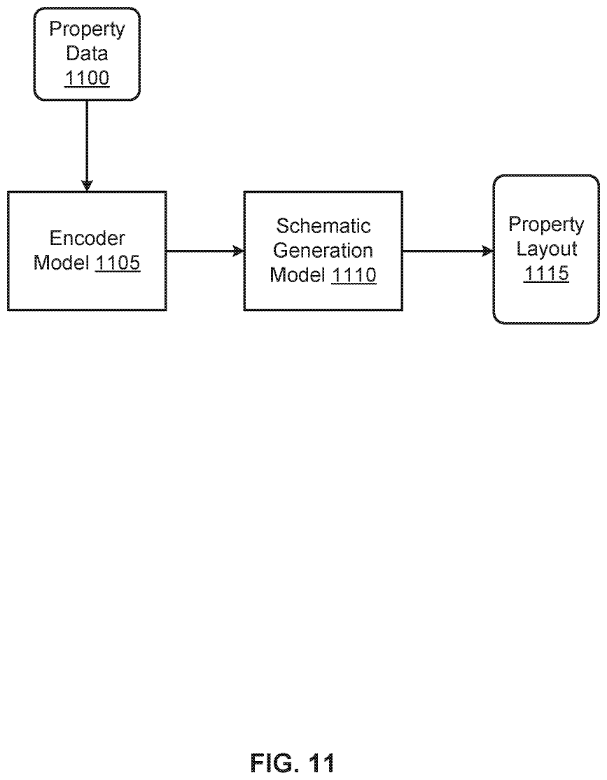

FIG. 4 shows an example of a pipeline for listing generation according to aspects of the present disclosure. The example shown includes property image(s) 400, property data 405, smart contract 410, public listing 415, and private listing 420. Property data 405 is an example of, or includes aspects of, the corresponding element described with reference to FIG. 11. Smart contract 410 is an example of, or includes aspects of, the corresponding element described with reference to FIGS. 3, and 5-7.

In this example, a smart contract 410 (or an AI/ML model included therein) receives input information including property image(s) 400 and property data 405. One or more models included in the smart contract 410 process the information to generate both a public listing 415 and private listing 420. For example, a classification model may be used to determine which data of property data 405 should belong to a private or privileged access-level, and which data is suitable for the public listing. An NLG model may, for example, generate additional description of the property to be included in the listing. Some examples of a public property listing include: images of the property, address, number of rooms, square footage, suggested price, and a listing description. In some cases, the NLG model generates an aesthetic and naturally flowing description of the property based on a minimal input of the property features. In some embodiments, an image/video to text model processes the property image(s) 400 to produce a description of the images for incorporation into the listing descriptions.

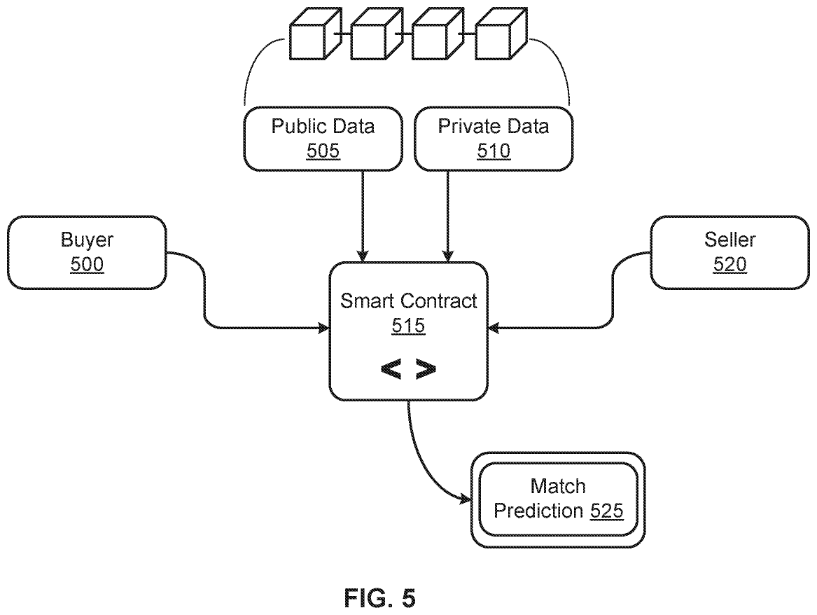

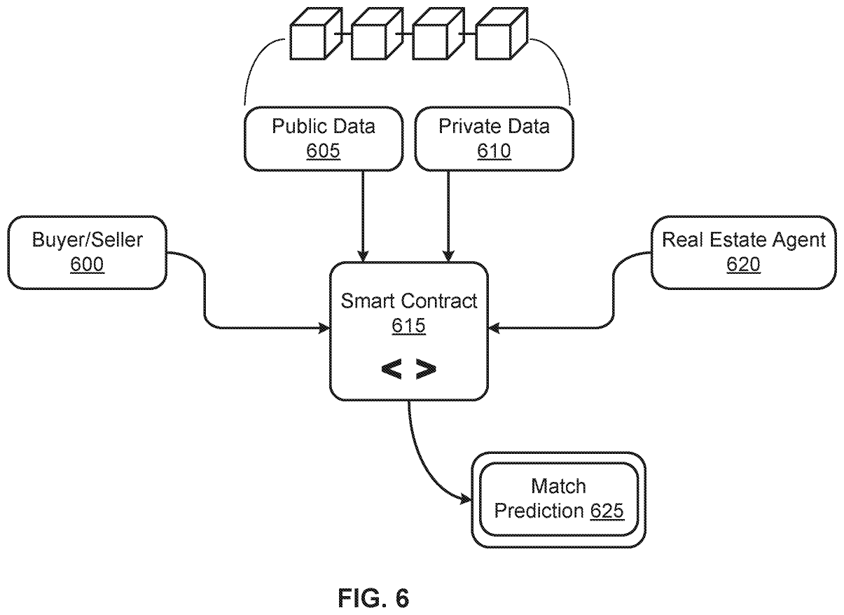

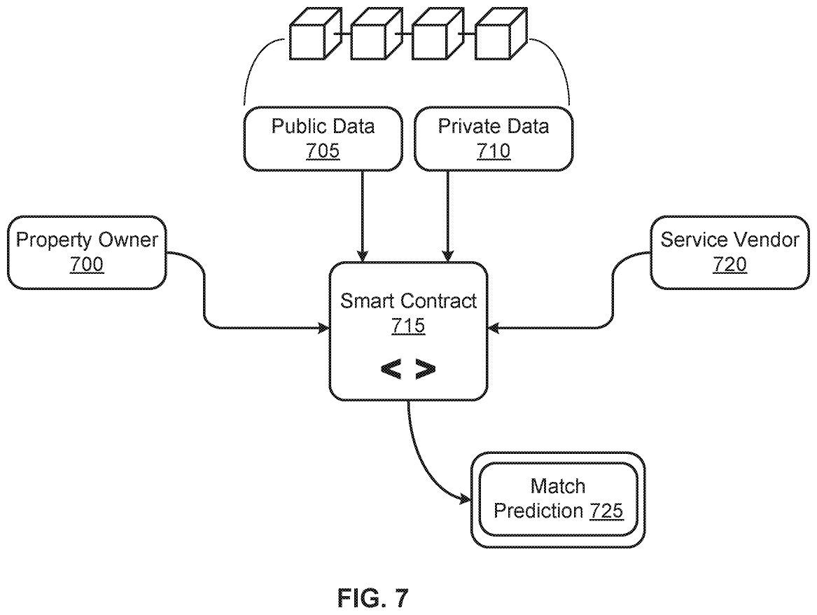

FIG. 5 shows an example of a pipeline for buyer 500 to seller 520 matching according to aspects of the present disclosure. The example shown includes buyer 500, public data 505, private data 510, smart contract 515, seller 520, and match prediction 525. Public data 505 is an example of, or includes aspects of, the corresponding element described with reference to FIGS. 6 and 7. Private data 510 is an example of, or includes aspects of, the corresponding element described with reference to FIGS. 6 and 7. Smart contract 515 is an example of, or includes aspects of, the corresponding element described with reference to FIGS. 3, 4, 6, and 7. Match prediction 525 is an example of, or includes aspects of, the corresponding element described with reference to FIGS. 6 and 7.

In this example, buyer 500 queries the real estate matching system for a property. The property may belong to be associated with seller 520. The smart contract 515 retrieves public data 505 or private data 510 to predict if the property of seller 520 is a match. This prediction, match prediction 525, may be in the form of an output vector or scalar. According to some aspects, smart contract 515 computes a rating factor between buyer 500 and the property of seller 520, and then computes match prediction 525 based on the rating factor. According to some aspects, smart contract 515 retrieves only private data 510 in response to a property of buyer 500 or of the request made by buyer 500.

FIG. 6 shows an example of a pipeline for buyer or seller 600 to agent matching according to aspects of the present disclosure. The example shown includes buyer or seller 600, public data 605, private data 610, smart contract 615, real estate agent 620, and match prediction 625. In this example, smart contract 615 may compute match prediction 625 using the same or similar methods described with reference to FIG. 5. In some examples, smart contract 615 computes a user-user match between buyer or seller 600 and real estate agent 620. In other examples, smart contract 615 computes a user-property match between buyer or seller 600 and one or more properties associated with real estate agent 620. In some embodiments, buyer or seller 600 queries the real estate matching system with natural language using a prompt. In some embodiments, buyer or seller 600 queries the real estate matching system using a user interface, such as the one described with reference to FIGS. 1-2.

Similarly, FIG. 7 shows an example of a pipeline for vendor matching according to aspects of the present disclosure. The example shown includes property owner 700, public data 705, private data 710, smart contract 715, service vendor 720, and match prediction 725. In this example, smart contract 715, may compute match prediction 725 using the same or similar methods described with reference to FIGS. 5-6. Property owner 700 may include additional information in their request to the real estate matching system, such as a natural language description of a desired service, or some other indication of the desired service. Examples of services available to users can include mortgage underwriting services, insurance, renovations, maintenance, and the like.

FIG. 8 shows an example of public and private layers according to aspects of the present disclosure. The example shown includes public blockchain component 800, private blockchain component 810, and blockchain 820. Public blockchain component 800 is an example of, or includes aspects of, the corresponding element described with reference to FIG. 2. Private blockchain component 810 is an example of, or includes aspects of, the corresponding element described with reference to FIG. 2.

Public blockchain component 800 interacts with blockchain 820. Public blockchain component 800 may submit transactions to be added to blockchain 820, and may prevent unauthorized transactions from being submitted to blockchain 820. A blockchain 820 is described with reference to FIG. 2. An example of blockchain 820 is Flow blockchain, though the methods described herein are not limited to operations thereon. In one aspect, public blockchain component 800 includes public blocks 805. For example, public blockchain component 800 may submit transactions with public data according to instruction from a smart contract. Public blocks 805 may include general information about a property or a user. For example, in the case of a property listing, public blocks 805 may include the property address, square footage, images, and features.

Private blockchain component 810 also interacts with blockchain 820. In one aspect, private blockchain component 810 includes privileged blocks 815. For example, private blockchain component 810 may submit transactions with sensitive or privileged data according to instruction from a smart contract. Privileged blocks 815 may include privileged information about a property or a user. For example, in the case of a property listing, privileged blocks 815 may include unsettled offers for the property, identifying information about the buyers and the sellers, results from inspections, appraisals, and the like.

Accordingly, by separating the blocks that are used on a blockchain, embodiments implement different privileged layers onto the blockchain, thereby allowing for multi-level verification according to each user's permissions. Furthermore, smart contract functionality may be tailored to different types of available information. In at least one embodiment, a controlling user or authority includes the highest level of permissions, enabling the master user/wallet/authority to develop different automations or functionalities using data from the public and private blocks.

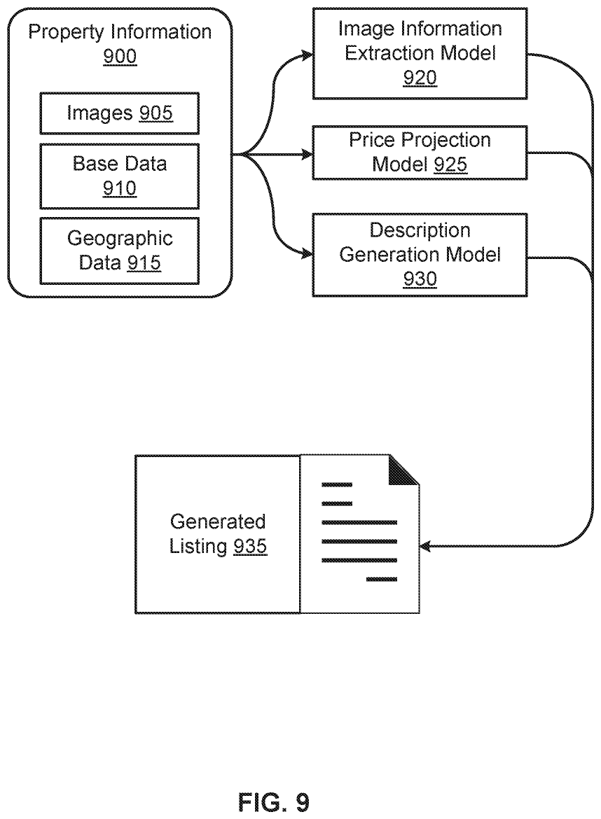

FIG. 9 shows an example of listing generation models according to aspects of the present disclosure. The example shown includes property information 900, image information extraction model 920, price projection model 925, description generation model 930, and generated listing 935.

In this example, property information 900 including images 905, base data 910, and geographic data 915 is input to one or more AI/ML models. The inputs may be transformed into a representation that is understandable by each model. For example, images 905 may be re-shaped into one or more tensors that, e.g. image information extraction model 920 is designed to understand.

Image information extraction model 920 includes a trained model capable of visual understanding. Examples of such models include CLIP, BLIP, visual transformer models, and others. In some examples, image information extraction model 920 processes images 905 and outputs a description of the images. This description may be fed into another model, such as description generation model 930, to be expanded upon or tailored for the final generated listing 935. Additionally or alternatively, the description may be attached to the input images so that the description is displayed adjacent to the images in the generated listing.

Price projection model 925 is configured to predict one or more prices of a property based on the property information. For example, price prediction model 925 may receive a property representation vector including one or more features about the property such as square footage, bathrooms, previous price(s), and the like, and predict a current or future price of the property based on the property representation vector. Embodiments of price projection model 925 include an ANN trained on training tuples including many property representation vectors and price pairs. The price prediction and the training may also be based on geographic data 915. Geographic data 915 may include, e.g., coordinate data, though embodiments are not limited thereto and other representations of geographic placement may be used such as city names.

Description generation model 930 is configured to generate a natural language description of the property. Description generation model 930 may receive both the property information 900, outputs from other models (such as the models described above), or some combination thereof. Embodiments of description generation model 930 include an NLG model such as Flan-T5, GPT, or others. In some examples, description generation model 930 is based on a pre-trained language model, and is then fine-tuned with additional training data. Generated listing 935 may include the generated description, as well as other features about the property to comply with listing regulations. According to some aspects, multiple versions of generated listing 935 are produced for different access levels of users.

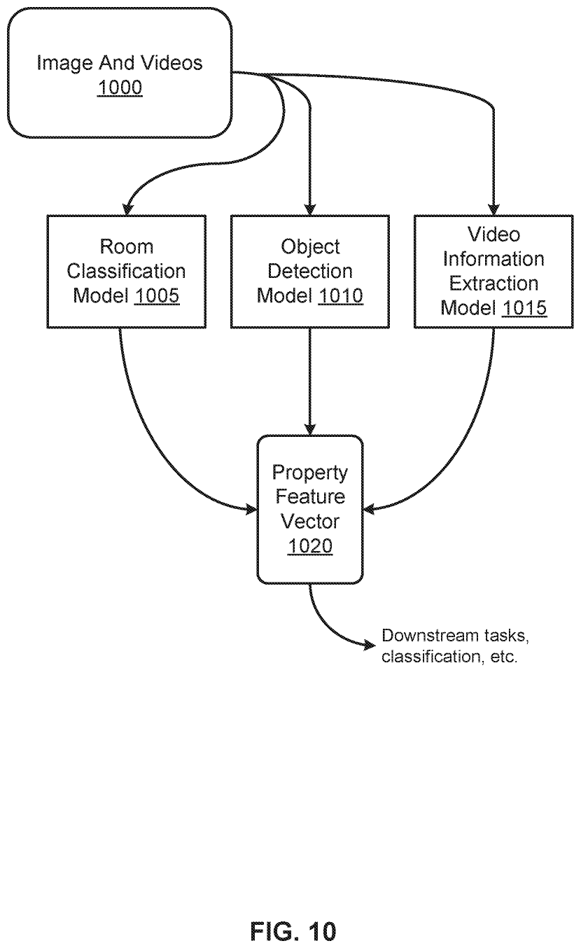

FIG. 10 shows an example of a property compliance pipeline according to aspects of the present disclosure. The example shown includes images and videos 1000, room classification model 1005, object detection model 1010, video information extraction model 1015, and property feature vector 1020.

In this example, image data from images and videos 1000 are input to one or more AI/ML models. For example, room classification model 1005 may use the image data to classify a room as a certain type of room, such as a bathroom or a master bedroom. Object detection model 1010 may process the image data to determine existing objects in a room, or to make recommendations for objects to add to a room. Video information extraction model 1015 may process moving image data to extract features from the room that might not be captured from a still image model, such as the image information extraction model described with reference to FIG. 9. For example, the video information extraction model 1015 may produce an output vector that encodes the relationships between rooms in the house, which can be a factor in determining compliance. In some embodiments, an additional model processes a natural language description of the property or of an inspection result of the property, and enumerates one or more compliance issues of the property based on the description. In some examples, property feature vector 1020 is a summary vector combines the results from the above-described models. The property feature vector 1020 may be used for downstream tasks such as classification, additional description generation, and the like. In some embodiments, one or more features or aspects determined from the property according to these methods is kept from public view by using the privileged layer of the blockchain.

FIG. 11 shows an example of a layout generation pipeline according to aspects of the present disclosure. The example shown includes property data 1100, encoder model 1105, schematic generation model 1110, and property layout 1115. Property data 1100 is an example of, or includes aspects of, the corresponding element described with reference to FIG. 4.

In this example, an encoder model 1105 processes property data 1100 to compute a property encoding. The property encoding is an intermediate vector that captures features about a property that are understandable by a decoder, such as schematic generation model 1110. Embodiments of encoder model 1105 include an attention-based encoder such as a transformer model. At least one embodiment of encoder model 1105 includes an encoder configured to generate a latent vector that includes visual characteristics; for example, the CLIP encoder.

Schematic generation model 1110 then decodes the property encoding to produce property layout 1115. Embodiments of schematic generation model 1110 include a generative model configured to generate image data, such as a diffusion model or a GAN. However, embodiments are not necessarily limited thereto, and schematic generation model 1110 may be configured to generate another representation of a layout, such as a layout specification according to a schema, such as a particularly formatted JSON object. Accordingly, embodiments are configured to generate property layout 1115, which may be an image or a specification, based on one or more property attributes from property data 1100.

### Listing Retrieval and Generation Techniques

A method for automated real estate listing, matching, and transactions on a blockchain-based network is described. One or more aspects of the method include obtaining, by a smart contract operating on a blockchain-based distributed computer network, public information for a real estate property and private information for the real estate property; providing, by the smart contract, the public information via a public access layer of the blockchain-based distributed computer network in response to a public request for information about the real estate property; and providing, by the smart contract, the private information via a privileged access layer of the blockchain-based distributed computer network in response to a verified request for information about the real estate property.

Some examples of the method, apparatus, non-transitory computer readable medium, and system further include performing, by the smart contract, a private transaction via the privileged access layer of the blockchain-based distributed computer network, wherein the private transaction transfers a property right for the real estate property.

Some examples of the method, apparatus, non-transitory computer readable medium, and system further include receiving, by the smart contract, a first verification from a first user via the privileged access layer of the blockchain-based distributed computer network. Some examples further include receiving, by the smart contract, a second verification from a second user via the privileged access layer of the blockchain-based distributed computer network, wherein the private transaction is performed based on the first verification and the second verification.

Some examples of the method, apparatus, non-transitory computer readable medium, and system further include generating, by a machine learning model operating off of the blockchain-based distributed computer network, a property matching prediction in response to the verified request. Some examples further include providing a result of the property matching prediction to the smart contract, wherein the private information is based on the result of the property matching prediction. In some aspects, the property matching prediction comprises a ranking of a plurality of real estate properties. Some examples further include receiving user information, wherein the property matching prediction is based on the user information. In some examples, the property matching prediction is computed according to one or more methods described in U.S. Pat. No. 11,093,992.

Some examples of the method, apparatus, non-transitory computer readable medium, and system further include identifying a transaction on the blockchain-based distributed computer network. Some examples further include updating the machine learning model based on the transaction.

Some examples of the method, apparatus, non-transitory computer readable medium, and system further include computing a plurality of component rating factors using a plurality of machine learning models. Some examples further include combining the plurality of component rating factors using an ensemble algorithm to obtain the property matching prediction. Some examples of the method, apparatus, non-transitory computer readable medium, and system further include identifying a user based on the property matching prediction, wherein the private information is provided to the user in response to the verified request.

Some examples of the method, apparatus, non-transitory computer readable medium, and system further include restricting access to the private information via the public access layer of the blockchain-based distributed computer network. Some examples of the method, apparatus, non-transitory computer readable medium, and system further include transferring, by the smart contract, a monetary value via the privileged access layer of the blockchain-based distributed computer network in response to a verified transaction.

Some examples of the method, apparatus, non-transitory computer readable medium, and system further include generating, by the smart contract, a construction request for the real estate property. Some examples further include modifying the real estate property in response to the construction request. Some examples of the method, apparatus, non-transitory computer readable medium, and system further include identifying a sender of the verified request. Some examples further include verifying an authorization of the sender, wherein the private information is based on the authorization.

FIG. 12 shows an example of a method 1200 for retrieving privileged information according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1205, a user requests information about a property. The user may do so via a user interface as described with reference to FIGS. 1-2. The user may make the request by selecting a visual element from a GUI, or by typing a natural language request into a text field.

At operation 1210, the system provides public information. For example, if the user makes the request without specifying a permission level, provides incorrect or outdated authentication, or fails to provide an access fee, or the like, the system may default to presenting public information. Additional information regarding public information is described with reference to FIG. 3.

At operation 1215, the user provides authentication. Authentication may include logging in to a user portal with login credentials, inputting a secret key into the system, or paying the access fee, or some combination thereof. For example, the user may provide authentication that associates themselves with a transaction or pending transaction with a property identified in the request.

At operation 1220, the system verifies the authentication. For example, the system may verify the user by corresponding their online profile with a wallet on the blockchain.

At operation 1225, the system provides the privileged information based on the verified authentication. The access permissions of the user may be managed by a public blockchain component and a private blockchain component, and one or more smart contracts, as described in the pipelines illustrated with reference to FIGS. 3-11.

FIG. 13 shows an example of a method 1300 for automated listing generation and user matching according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the system obtains, by a smart contract operating on a blockchain-based distributed computer network, public information for a real estate property and private information for the real estate property. In some cases, the operations of this step refer to, or may be performed by, a public blockchain component and a private blockchain component of a real estate matching apparatus as described with reference to FIG. 2. Both the public information and the private information may be stored on a distributed ledger system, such as a blockchain-based computer network.

At operation 1310, the system provides, by the smart contract, the public information via a public access layer of the blockchain-based distributed computer network in response to a public request for information about the real estate property. In some cases, the operations of this step refer to, or may be performed by, a public blockchain component as described with reference to FIGS. 2 and 8. The information may be displayed via a user interface.

At operation 1315, the system provides, by the smart contract, the private information via a privileged access layer of the blockchain-based distributed computer network in response to a verified request for information about the real estate property. In some cases, the operations of this step refer to, or may be performed by, a private blockchain component as described with reference to FIGS. 2 and 8. Additional information regarding different access levels of a user is provided with reference to FIGS. 2-3 and FIG. 12.

FIG. 14 shows an example of a computing device 1400 according to aspects of the present disclosure. The example shown includes computing device 1400, processor(s), memory subsystem 1410, communication interface 1415, I/O interface 1420, user interface component(s), and channel 1430.

In some embodiments, computing device 1400 is an example of, or includes aspects of, a real estate matching apparatus illustrated in FIGS. 1-2. In some embodiments, computing device 1400 includes one or more processors 1405 that can execute instructions stored in memory subsystem 1410 to obtain public information for a real estate property and private information for the real estate property; provide the public information via a public access layer of a blockchain-based distributed computer network in response to a public request for information about the real estate property; and provide the private information via a privileged access layer of the blockchain-based distributed computer network in response to a verified request for information about the real estate property.

According to some aspects, computing device 1400 includes one or more processors 1405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or via hardware components controlled by the I/O controller.

According to some aspects, user interface component(s) 1425 enable a user to interact with computing device 1400. In some cases, user interface component(s) 1425 include an audio device, such as an external speaker system, an external display device such as a display screen, an input device (e.g., a remote control device interfaced with a user interface directly or through the I/O controller), or a combination thereof. In some cases, user interface component(s) 1425 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for automated listing generation and user matching, comprising:
obtaining, by a smart contract operating on a blockchain-based distributed computer network, public information for a real estate property and private information for the real estate property;
providing, by the smart contract, the public information via a public access layer of the blockchain-based distributed computer network in response to a public request for information about the real estate property; and
providing, by the smart contract, the private information via a privileged access layer of the blockchain-based distributed computer network in response to a verified request for information about the real estate property.

2. The method of claim 1, further comprising:
performing, by the smart contract, a private transaction via the privileged access layer of the blockchain-based distributed computer network, wherein the private transaction transfers a property right for the real estate property.

3. The method of claim 2, further comprising:
receiving, by the smart contract, a first verification from a first user via the privileged access layer of the blockchain-based distributed computer network; and
receiving, by the smart contract, a second verification from a second user via the privileged access layer of the blockchain-based distributed computer network, wherein the private transaction is performed based on the first verification and the second verification.

4. The method of claim 1, further comprising:
generating, by a machine learning model operating off of the blockchain-based distributed computer network, a property matching prediction in response to the verified request; and
providing a result of the property matching prediction to the smart contract, wherein the private information is based on the result of the property matching prediction.

5. The method of claim 4, wherein:
the property matching prediction comprises a ranking of a plurality of real estate properties.

6. The method of claim 4, further comprising:
receiving user information, wherein the property matching prediction is based on the user information.

7. The method of claim 4, further comprising:
identifying a transaction on the blockchain-based distributed computer network; and
updating the machine learning model based on the transaction.

8. The method of claim 4, further comprising:
computing a plurality of component rating factors using a plurality of machine learning models; and
combining the plurality of component rating factors using an ensemble algorithm to obtain the property matching prediction.

9. The method of claim 4, further comprising:
identifying a user based on the property matching prediction, wherein the private information is provided to the user in response to the verified request.

10. The method of claim 1, further comprising:
restricting access to the private information via the public access layer of the blockchain-based distributed computer network.

11. The method of claim 1, further comprising:
transferring, by the smart contract, a monetary value via the privileged access layer of the blockchain-based distributed computer network in response to a verified transaction.

12. The method of claim 1, further comprising:
generating, by the smart contract, a construction request for the real estate property; and
modifying the real estate property in response to the construction request.

13. The method of claim 1, further comprising:
identifying a sender of the verified request; and
verifying an authorization of the sender, wherein the private information is based on the authorization.

14. A non-transitory computer readable medium storing code, the code comprising instructions executable by a processor to:
obtain, by a smart contract operating on a blockchain-based distributed computer network, public information for a real estate property and private information for the real estate property;
provide, by the smart contract, the public information via a public access layer of the blockchain-based distributed computer network in response to a public request for information about the real estate property; and
provide, by the smart contract, the private information via a privileged access layer of the blockchain-based distributed computer network in response to a verified request for information about the real estate property.

15. The non-transitory computer readable medium of claim 14, wherein the code further comprises instructions executable by the processor to:
perform, by the smart contract, a private transaction via the privileged access layer of the blockchain-based distributed computer network, wherein the private transaction transfers a property right for the real estate property.

16. The non-transitory computer readable medium of claim 15, wherein the code further comprises instructions executable by the processor to:
receive, by the smart contract, a first verification from a first user via the privileged access layer of the blockchain-based distributed computer network; and
receive, by the smart contract, a second verification from a second user via the privileged access layer of the blockchain-based distributed computer network, wherein the private transaction is performed based on the first verification and the second verification.

17. An apparatus comprising:
at least one processor;
at least one memory storing instructions executable by the at least one processor;
the apparatus further comprising a public blockchain component configured to provide public information via a public access layer of a blockchain-based distributed computer network in response to a public request for information about a real estate property; and
a privileged blockchain component configured to provide private information via a privileged access layer of the blockchain-based distributed computer network in response to a verified request for information about the real estate property.

18. The apparatus of claim 17, further comprising:
a smart contract component configured to create and execute a smart contract, wherein the smart contract operates on the blockchain-based distributed computer network.

19. The apparatus of claim 18, wherein:
the smart contract includes instructions configured to: compute a plurality of component rating factors using a plurality of machine learning models; and compute the plurality of component rating factors using an ensemble algorithm to obtain a property matching prediction.

20. The apparatus of claim 18, wherein:
the smart contract includes instructions configured to: perform a private transaction via the privileged access layer of the blockchain-based distributed computer network, wherein the private transaction transfers a property right for the real estate property.
